(19) United States
(12) Patent Application Publication
(10) Pub. No.: US 2006/0280717 A1
(43) Pub. Date: Dec. 14, 2006

(54) Body weight reduction method by ingestion of glucomannan

(75) Inventors: Hideki Shimizu, Hiroshima (JP); Hisao Shimizu, Hiroshima (JP)

Correspondence Address: RADER FISHMAN & GRAUER PLLC, LION BUILDING, 1233 20TH STREET N.W., SUITE 501, WASHINGTON, DC, 20036, US

(73) Assignee: SHIMIZU CHEMICAL CORPORATION

(21) Appl. No.: 11/136,530

(22) Filed: May 25, 2005

(51) Int. Cl. A61Q 9/00

(52) U.S. Cl. 424/74

(57) ABSTRACT

The present invention relates to a body weight reduction method by ingestion of glucomannan, in which a diet effect is realized with safety without being affected in one's body or health. The method of the present invention permits a reduction in body weight of one whose Body Mass Index (BMI) is high by giving, to the above one within 40 minutes before each meal, a diet food mainly containing glucomannan obtained through extraction from an arum root, specifically, glucomannan having an average molecular weight of 50,000 or more. The above diet food contains 50% or more of the glucomannan, and an intake of the diet food is preferably within the range of 3.5 g to 8.0 g per day. The Body Mass Index (BMI) of one supposed to take in the diet food is limited to 23 or more.

### BACKGROUND OF THE INVENTION

1. Field of the Invention

This invention relates to a body weight reduction method by glucomannan ingestion that is made under conditions of safety without being affected in one's body or health.

2. Description of the Prior Art

It has been already well known that glucomannan refined from an arum root is used as a diet foodstuff to permit a reduction in one's body weight, as shown in a reference such as U.S. Pat. No. 3,973,008.

The above reference also makes mention of an advantage that a dose of glucomannan has an effect of reducing not only one's body weight but also one's blood pressure or cholesterol level.

Although the glucomannan is well known as a diet material to a large number of people, all one has to do has been heretofore to simply take in the glucomannan. Thus, a way of simply taking in the glucomannan realizes a temporary diet effect, whereas it changes a meal balance for the worse to develop a rebound symptom, resulting in no expectation of an exact body weight reduction.

### SUMMARY OF THE INVENTION

The invention in the above reference is of having been worked out with a company to which an inventor of the present invention belongs, and the present invention is based on a result of researches having been further made on the invention in the above reference.

It is an object of the present invention to provide a method of producing a more satisfactory diet effect with safety while keeping a meal balance by making ingestion of glucomannan of a desired molecular weight through establishment of a relation to usual meal timing.

Another object of the present invention is to further heighten the diet effect by limiting, to the optimum, an intake of a diet food containing 50% or more of glucomannan having a molecular weight of 50,000 or more.

A further object of the present invention is to produce the more satisfactory diet effect by giving the glucomannan to one whose Body Mass Index (which will be hereinafter referred to as BMI) is high.

According to a first aspect, a method of the present invention to attain the above objects is characterized by permitting a reduction in body weight of one whose BMI is high by giving, to the above one within 40 minutes, preferably, 30 minutes before each meal, a diet food mainly containing glucomannan obtained through extraction from an arum root, specifically, glucomannan having an average molecular weight of 50,000 or more.

According to a second aspect, the method of the present invention is characterized in that the above diet food contains 50% or more of the above glucomannan.

According to a third aspect, the method of the present invention is characterized in that an intake of the above diet food is within the range of 3.5 g to 8.0 g per day, preferably, 3.9 g to 7.8 g per day.

According to a fourth aspect, the method of the present invention is characterized in that the BMI of one supposed to take in the diet food is limited to 23 or more.

### BRIEF DESCRIPTION OF THE DRAWINGS

Other features and advantages of the invention will become more apparent from the following description of an embodiment with reference to the accompanying drawings in which;

FIG. 1 shows graph data depending on a treatment period in the case where ingestion of 3.9 g of glucomannan per day was made;

FIG. 2 shows graph data depending on a treatment period in the case where ingestion of 7.8 g of glucomannan per day was made; and

FIG. 3 shows graph data showing a comparison in body weight reduction effect between a placebo group (a control group) and a glucomannan group.

### DETAILED DESCRIPTION OF THE PREFERRED EMBODIMENT

Glucomannan for use in the present invention is specified as a storable water-soluble polysaccharide contained in a tuber (an arum root) of Amorphophallus Konjak K.Koch that belongs to an Araceae group generally in view of a systematic botany. The glucomannan shares about 10% in the tuber (the arum root).

In Japan, a product obtained by the process of, after washing, with water, the arum root having been harvested in a period from November to the beginning of December, slicing the arum root into thin pieces, then drying and mechanically pulverizing the thin pieces of the arum root into flour, and finally removing starches etc. from the flour is available as an edible konjak material, which is also called refined konjak flour (unrefined glucomannan). However, the above refined konjak flour contains a large quantity of impurities etc., in which case, a way of taking in the above refined konjak flour as it is causes a large quantity of harmful matters to be taken into a living body, and is therefore supposed to be undesirable.

For reference, analyses of refined glucomannan and refined konjak flour (unrefined glucomannan) are shown in Table 1.

TABLE 1

| | | GLUCOMANNAN | REFINED |
|---|---|---|---|
| | | (REFINED | KONJAK FLOUR |
| | | GLUCOMANNAN OF | (UNREFINED |
| CHARACTERISTICS | | HIGH PURITY) | CLUCOMANNAN) |
| QUALITY | 1) PROPERTIES: EXTERNAL | WHITE POWDER | YELLOWISH |
| CHARACTERISTICS | APPEARANCE | | WHITE POWDER |
| | | | (CONTAINING |
| | | | BLACK |
| | | | PARTICLES) |
| | SMELL | ALMOST NONE | SMELL LIKE |
| | | | FISH |
| | GRAIN SIZE | 35 MESHES (420 μm)˜ | 35 MESHES (420 μm) |
| | | 120 MESHES (125 μm) 90% | ALL OVER |
| | | OR MORE | |
| | 2) GENERAL ITEMS: | 3.1 | 9.2 |
| | DRYING LOSS % | | |
| | PROTEIN % | 0.5 | 3.4 |
| | LIPID | 0.0 | 1.1 |
| | ASH % | 0.6 | 4.5 |
| | 3) PURITY (DRIED PRODUCT | 98.9 | 75.0 |
| | VALUE) FOOD FIBERS % | | |
| | 4) VISCOSITY: 25° C., 1%, mPa · s | 136,000 (7hr) | 46,200 (hr) |
| | 5) SANITARY ITEMS: | NOT FOUND | <10 |
| | HEAVY METAL ppm | (MINIMUM DETECTABLE: | |
| | | 2 ppm) | |
| | ARSENIC ppm | NOT FOUND | <2 |
| | | (MINIMUM DETECTABLE: | |
| | | 0.2 ppm) | |
| | NUMBER OF GENERAL | <300 | <3,000 |
| | VITAL BACTERIUM | | |
| | SULFITE ppm | NOT FOUND | 520 |
| | | (MINIMUM DETECTABLE: | |
| | | 4 ppm) | |
| | TRIMETHYLAMINE ppm | <4 | 450 |

Further, the refined konjak flour has a unique smell, so that it is difficult to take in the refined konjak flour as it is. In the case of the edible konjak, there is no problem of a smell by reason that a quantity of refined konjak flour added meets a low concentration as much as 2.5% to 3.0%.

In this connection, the present invention suggests taking extraction with alcohol to highly purify the arum root or the unrefined glucomannan containing the large quantity of impurities so that use of glucomannan of high purity and high safety is attained. The glucomannan varies in molecular weight depending on growing districts, breeds, and types of the arum root etc., in which case, however, the molecular weight of the glucomannan is made adjustable with a technology of refinement.

A physiological function of the glucomannan has been proved to be effective in relieving constipation, reducing cholesterol, and controlling a blood sugar level. The refined glucomannan (such as the glucomannan by the trade name of “PROPOL A”, “RHEOLEX RS, “AMOPHOL L”, and “FIBERTRIM”, for instance) (manufactured by Shimizu Chemical Corporation) and others are available as those providing the effects described the above.

The present invention may meet expectations of a body weight reduction not by simply taking in the glucomannan, but by taking in the glucomannan provided that a time to take in the glucomannan is limited to within 40 minutes, preferably, 30 minutes before each meal. Further, the present invention confirmed the body weight reduction valuable for one whose BMI (Body Mass Index) is high. Furthermore, it was also suggested that a period of treatment of the ingestion of glucomannan is more significant than an intake of glucomannan.

The diet food for use in the present invention employs a food mainly containing the glucomannan having an average molecular weight of 50,000 or more, in which case, a food whose glucomannan content is 50% is preferably required to ensure that a satisfactory diet effect is attained. On the other hand, the glucomannan having the molecular weight of less than 50,000 lowers the diet effect.

Details of the present invention are now specifically described with reference to Examples.

### EXAMPLE 1

An experiment was conducted under conditions that 70 diabetics including males and females of various ages in the range of 20 to 75 years old are mainly specified as subjects.
(1) Experiment on ingestion of 3.9 g of glucomannan per day (1.3 g a time)

1.3 g of glucomannan was given to the subjects together with 100ml of water within 30 minutes before each of three meals a day, and measurements on the body weight of each subject earlier than lunch were made before the experiment, and after the lapse of four weeks (28^{th} day) and eight weeks (56^{th} day) from the beginning of the experiment. Incidentally, a group of the above subjects was composed of 22 males and 21 females, and the mean of the BMI representing the Body Mass Index was 25.90.
(2) Experiment on ingestion of 7.8 g of glucomannan per day (2.6 g a time)

2.6 g of glucomannan was given to the subjects together with 100 ml of water within 30 minutes before each of three meals a day, and the measurements on the body weight of each subject earlier than lunch were made before the experiment and after the lapse of four weeks (28th day) and eight weeks (56^{th} day) from the beginning of the experiment. Incidentally, a group of the above subjects was composed of 9 males and 18 females, and the mean of the BMI representing the Body Mass Index was 27.53.

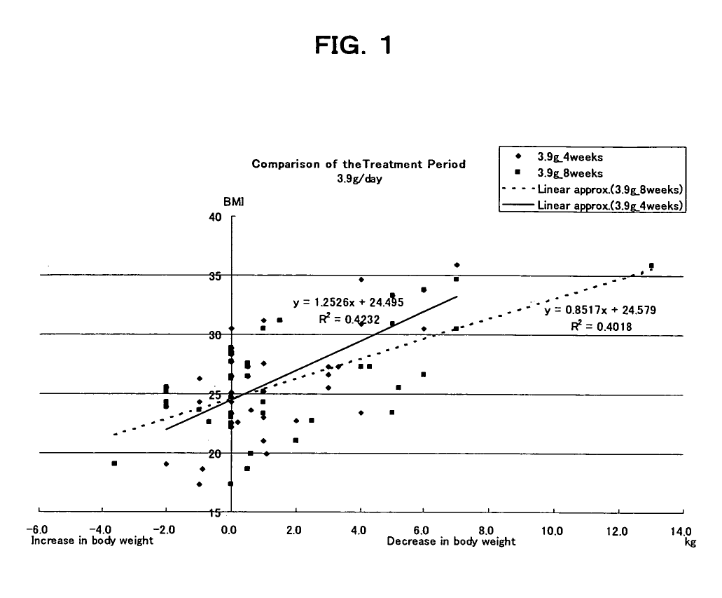

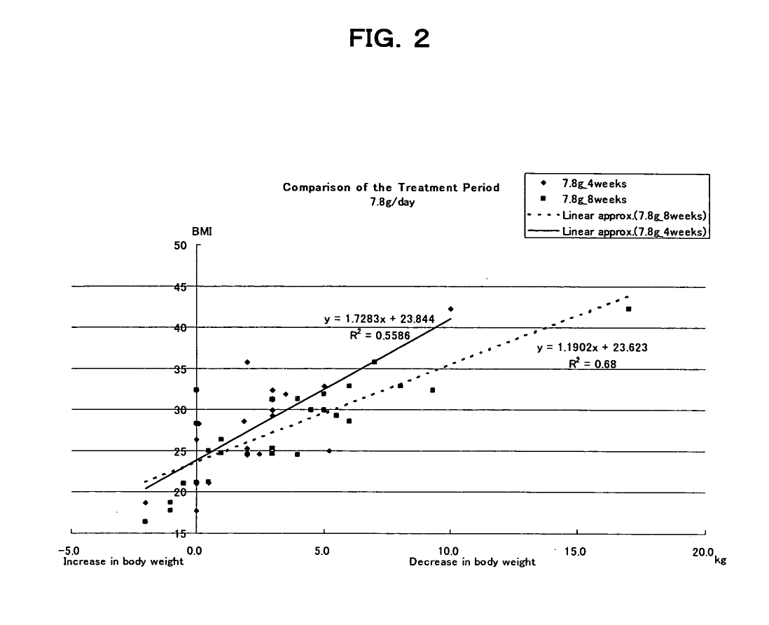

Referring to results of these experiments, results of the experiment (1) are shown in Table 2 and FIG. 1 (results of the body weight reduction and the BMI), and results of the experiment (2) are shown in Table 3 and FIG. 2 (results of the body weight reduction and the BMI).

TABLE 2

| SEX | AGE | 4 WEEKS | 8 WEEKS | BMI |
|---|---|---|---|---|
| M | 52 | 2.0 | 2.5 | 22.7 |
| F | 60 | 1.0 | 0.5 | 27.6 |
| F | 60 | −0.9 | 0.5 | 18.6 |
| F | 66 | 0.0 | 0.0 | 23.3 |
| M | 41 | 0.0 | 0.0 | 28.9 |
| M | 39 | 0.0 | 1.0 | 30.5 |
| F | 41 | 0.0 | 0.0 | 28.5 |
| F | 52 | 0.0 | 1.0 | 24.3 |
| M | 51 | −1.0 | 0.0 | 17.3 |
| M | 51 | 0.0 | 0.0 | 23.3 |
| M | 40 | 0.0 | 0.0 | 26.5 |
| F | 20 | −1.0 | 0.0 | 26.3 |
| F | 63 | 0.0 | −2.0 | 25.1 |
| M | 66 | 1.0 | 1.5 | 31.2 |
| M | 55 | 0.0 | 1.0 | 23.3 |
| M | 70 | 1.0 | 1.0 | 25.2 |
| M | 75 | 1.0 | 2.0 | 21.0 |
| M | 71 | 3.0 | 5.2 | 25.5 |
| M | 68 | 0.0 | 0.0 | 22.5 |
| F | 53 | 5.0 | 5.0 | 33.3 |
| M | 61 | 4.0 | 5.0 | 23.4 |
| F | 58 | 6.0 | 6.0 | 33.8 |
| F | 53 | 0.6 | −1.0 | 23.6 |
| M | 48 | 0.2 | −0.7 | 22.6 |
| F | 56 | 1.1 | 0.6 | 19.9 |
| M | 66 | 4.0 | 5.0 | 30.9 |
| F | 38 | 7.0 | 13.0 | 35.9 |
| F | 61 | 4.0 | 7.0 | 34.7 |
| M | 54 | 3.3 | 4.3 | 27.3 |
| F | 20 | 6.0 | 7.0 | 30.5 |
| F | 62 | 0.5 | 0.5 | 26.5 |
| F | 56 | 0.5 | 0.5 | 27.3 |
| F | 55 | 0.0 | 0.0 | 27.7 |
| M | 54 | 3.0 | 4.0 | 27.3 |
| F | 54 | −2.0 | −3.6 | 19.0 |
| M | 72 | 1.0 | 0.0 | 23.0 |
| M | 50 | 0.0 | 0.0 | 28.3 |
| F | 67 | −1.0 | −2.0 | 24.3 |
| F | 58 | 3.0 | 6.0 | 26.6 |
| M | 51 | 0.0 | 0.0 | 22.2 |
| M | 67 | 0.0 | 0.0 | 24.7 |
| F | 61 | −2.0 | −2.0 | 23.9 |
| M | 33 | −2.0 | −2.0 | 25.5 |
| Mean | | 1.12 | 1.55 | 25.90 |
| S.D. | | 2.21 | 3.16 | 4.24 |

(BODY WEIGHT REDUCTION AFTER 4 WEEKS = 0.33 (BMI) − 7.45 CORRELATION COEFFICIENT 0.640)
(BODY WEIGHT REDUCTION AFTER 8 WEEKS = 0.47 (BMI) − 10.66 CORRELATION COEFFICIENT 0.632)

TABLE 3

| | | | | |
|---|---|---|---|---|
| F | 66 | 2.0 | 7.0 | 35.7 |
| M | 63 | 5.0 | 5.0 | 29.9 |
| F | 65 | 3.0 | 5.5 | 29.3 |
| F | 55 | 3.5 | 5.0 | 31.9 |
| F | 30 | 10.0 | 17.0 | 42.2 |
| F | 57 | 3.0 | 4.5 | 29.9 |
| F | 71 | 5.0 | 6.0 | 32.8 |
| M | 47 | 2.0 | 4.0 | 24.5 |
| F | 35 | 2.5 | 3.0 | 24.6 |
| F | 57 | 3.0 | 9.3 | 32.4 |
| F | 65 | 5.0 | 8.0 | 32.8 |
| M | 59 | 3.0 | 3.0 | 31.2 |
| F | 75 | 2.0 | 1.0 | 24.7 |
| F | 59 | 0.0 | 1.0 | 26.3 |
| F | 57 | 0.0 | 0.5 | 21.2 |
| M | 38 | 2.0 | 3.0 | 25.3 |
| M | 50 | 5.2 | 0.5 | 25.0 |
| F | 67 | 0.1 | 0.0 | 28.3 |
| M | 24 | 0.0 | −0.5 | 21.0 |
| M | 69 | 0.5 | 0.0 | 21.1 |
| F | 71 | 0.0 | −1.0 | 17.7 |
| F | 49 | 0.0 | 0.0 | 32.4 |
| F | 66 | 1.9 | 6.0 | 28.6 |
| F | 51 | −2.0 | −1.0 | 18.7 |
| F | 57 | −2.0 | −2.0 | 16.4 |
| Mean | | 2.16 | 3.29 | 27.53 |
| S.D | | 2.56 | 4.10 | 5.91 |

(BODY WEIGHT REDUCTION AFTER 4 WEEKS = 0.32 (BMI) − 6.65 CORRELATION COEFFICIENT 0.742)
(BODY WEIGHT REDUCTION AFTER 8 WEEKS = 0.57 (BMI) − 12.40 CORRELATION COEFFICIENT 0.825)

According to the above results, a significant correlation (p<0.05) was found between the BMI (Body Mass Index) and the body weight reduction. For the effect of the body weight reduction by the ingestion of glucomannan, it was proved that the intake of 3.9 g of glucomannan per day results in a satisfactory body weight reduction. Further, it was also proved that a more remarkable body weight reduction effect is provided for the subjects whose BMI (Body Mass Index) is higher than 23.

Furthermore, it was also proved that a prolongation of the treatment period is more significant than an increase in intake of glucomannan. As to unfavorable secondary effects of the glucomannan on the subjects, a temporary slight attack of diarrhea and a complaint of thirst were recognized, in which case, however, both were relatively not serious, and other unfavorable secondary effects than the above were not found.

### EXAMPLE 2

An experiment was conducted according to a double blind trial for eight weeks about the effect of the body weight reduction by the ingestion of glucomannan under conditions that 20 obese persons are specified as subjects. In this experiment, 20 subjects were selected at random from obese persons each having the body weight more than the average weight by 20% or more, and were then classified into two groups limited in distributions of the body weight and the height to an extremely small range. Then, a classification of the subjects into the two groups was made respectively to specify the two groups as a placebo group (a control group) and a glucomannan group at the time when the distributions of the body weight and the height in the two groups became approximately equal.

Table 4 shows the body weight, the height, and the BMI of the subjects in the placebo group (the control group) and the glucomannan group at the time of start of the experiment.

TABLE 4
BODY WEIGHT, HEIGHT, AND BMI OF PLACEBO GROUP
(CONTROL GROUP) AND GLUCOMANNAN GROUP AT TIME OF
START OF EXPERIMENT

| | MEAN | BODY | | |
|---|---|---|---|---|
| | BODY | WEIGHT | MEAN | MEAN |
| | WEIGHT | RANGE | BMI | HEIGHT |
| | (kg) | (kg) | (%) | (cm) |
| PLACEBO | 81.3 | 60.4˜97.2 | 51.2 | 160.5 |
| GROUP | | | | |
| (CONTROL | | | | |
| GROUP) | | | | |
| GLUCOMANNAN | 84.0 | 60.0˜99.0 | 54.5 | 160.0 |
| GROUP | | | | |
| SIGNIFICANT | n.s. | | n.s. | n.s. |
| DIFFERENCE | p > 0.90 | | p > 0.70 | p > 0.90 |

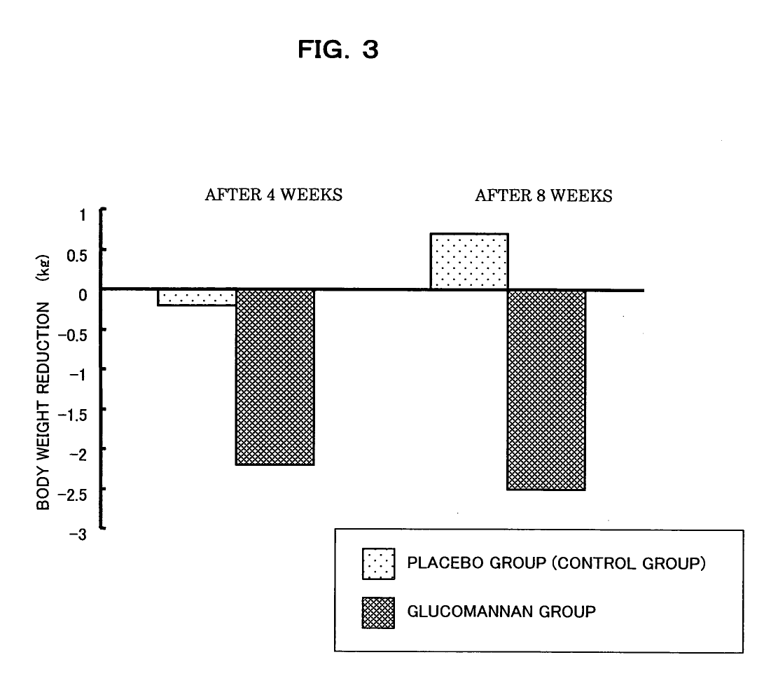

Capsules identical in shape, color and external appearance were respectively filled with 500 mg of starches for the placebo group (the control group) and 500 mg of glucomannan for the glucomannan group, and were then given to the subjects both in the placebo group and the glucomannan group. A way of taking in the capsules was to instruct the subjects both in the placebo group (the control group) and the glucomannan group to take in the capsules 30 minutes before each of three meals a day and also to keep the same meal pattern and exercise pattern as in an everyday life. FIG. 3 is a graph showing the results of the above experiment, specifically, a comparison in body weight reduction effect between the control group and the glucomannan group.

According to the above results, the increase by 0.7 Kg in body weight of the subjects in the placebo group (the control group) was recognized after the lapse of eight weeks from the beginning of the experiment. On the other hand, the reduction by 2.5 Kg in body weight of the subjects in the glucomannan group was recognized after the lapse of eight weeks from the beginning of the experiment. Further, no incidental effect on the subjects in the placebo group (the control group) was found, whereas an effect of slight relief of constipation on some of the subjects in the glucomannan group was recognized, and other conditions of the subjects were unchanged.

Consideration of Experiment Results

The ingestion of glucomannan revealed confirmations of body weight reduction effects as follows.
(1) The significant body weight reduction effect on the subjects of 23 or more in BMI (Body Mass Index) was proved.
(2) The prolongation of the treatment period was proved to be more significant.
(3) As the results of the experiment of the ingestion of glucomannan on the subjects in the placebo group (the control group) and the glucomannan group according to the double blind trial for eight weeks, the significant body weight reduction effect on the subjects in the glucomannan group was recognized, whereas no body weight reduction effect on the subjects in the placebo group (control group) was found.

It is appreciated from the above results that the glucomannan effectively acts on the body weight reduction, leading to applicability of the glucomannan to health foods (tablets, capsules and granules) or all the daily available foods.

What is claimed is:

1. A body weight reduction method by ingestion of glucomannan, characterized by permitting a reduction in body weight of one whose Body Mass Index (BMI) is high by giving, to said one within 40 minutes before each meal, a diet food mainly containing glucomannan obtained through extraction from an arum root, specifically, glucomannan having an average molecular weight of 50,000 or more.

2. The body weight reduction method by ingestion of glucomannan according to claim 1, wherein the diet good contains 50% or more of said glucomannan.

3. The body weight reduction method by ingestion of glucomannan according to claim 1 or 2, wherein an intake of the diet food is within the range of 3.5 g to 8.0 g per day.

4. The body weight reduction method by ingestion of glucomannan according to claim 1 or 2, wherein the Body Mass Index (BMI) of one supposed to take in the diet food is limited to 23 or more.
